(19) United States
(12) Patent Application Publication
(10) Pub. No.: US 2005/0260304 A1
(43) Pub. Date: Nov. 24, 2005

(54) Edible straw

(76) Inventors: Jake Thompson Schaffer, Honolulu, HI (US); Richard Joseph Schaffer, Honolulu, HI (US)

Correspondence Address: SCHOX PLC, 209 N. MAIN STREET #200, ANN ARBOR, MI, 48104, US

(21) Appl. No.: 10/851,375

(22) Filed: May 21, 2004

(51) Int. Cl. A23C 9/12

(52) U.S. Cl. 426/104

(57) ABSTRACT

The preferred embodiments of the invention include an edible straw with a first edible member and a second edible member. The preferred embodiments of the invention can be used to move liquid or particulate compositions from one container to another, such as moving a beverage from a glass into the mouth of the user.

### TECHNICAL FIELD

This patent discloses and claims a useful, novel, and unobvious invention for an edible straw.

### BACKGROUND

Consumers, and children in particular, enjoy using straws to drink beverages. A variety of novelty items combine a straw with an additional flavoring material to further enhance the drinking experience of a beverage. U.S. Pat. No. 6,565,899 to Cecere and U.S. Pat. No. 3,545,980 to Stranger disclose a hard candy within a straw that will dissolve into the beverage, thus changing the flavor of the beverage. U.S. Pat. No. 2,102,920 discloses an entirely edible straw made of a candy member and discloses the use of a liquid flavoring envelope. The popularity and variety of novelty straws indicates the value of further improvements to the straw and the drinking experience

### BRIEF DESCRIPTION OF THE FIGURES

FIG. 1 is a perspective view of a first preferred embodiment of the invention.

FIG. 2 is a partial cross-sectional view of a first variation of the first preferred embodiment.

FIG. 3 is a partial cross-sectional view of a second variation of the first preferred embodiment.

FIG. 4 is a perspective view of a second preferred embodiment of the invention.

FIG. 5 is a perspective view of a third preferred embodiment of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

The preferred embodiments of the invention include an edible straw with a first edible member and a second edible member. The preferred embodiments of the invention can be used to move liquid or particulate compositions from one container to another, such as moving a beverage from a glass into the mouth of the user. The term edible includes both completely digestible foods, such as candy, and partially digestible foods, such as chewing gum. The straw is sufficiently edible such that it can be consumed or chewed once the user no longer desires to use it as a straw.

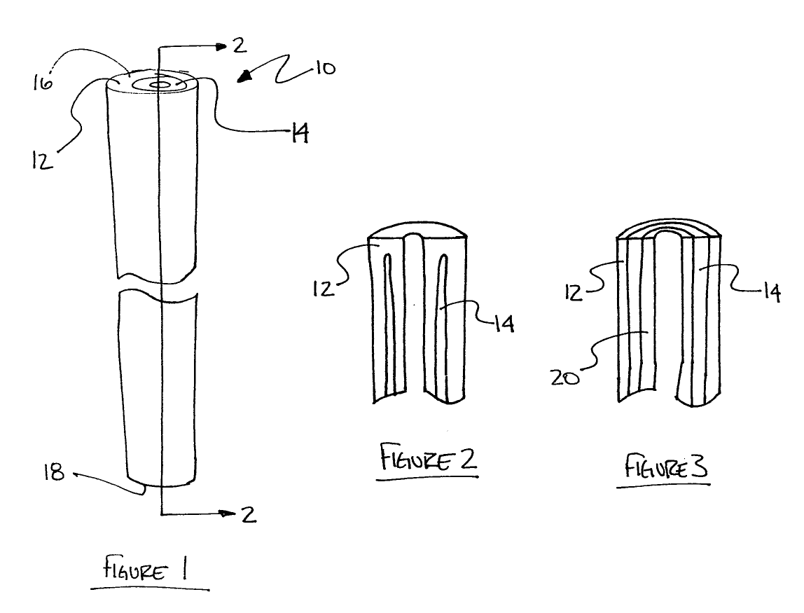

As shown in FIG. 1, in a first preferred embodiment, the edible straw 10 includes the first edible member 12 and the second edible member 14, which are formed in tubular shapes. The first edible member 12 and the second edible member 14 preferably form, either individually or together, an opening at one end 16 and an opening at the other end 18 of the straw. The openings at ends 16 and 18 and the tubular shapes of the first edible member 12 and the second edible members 14 permit the flow of liquid through the straw from one end to the other end. While this embodiment describes both the first edible member 12 and the second edible member 14 forming tubular shapes, the overall structure of the edible straw 10 between the one end 16 and the other end 18 may contain bends and edges, and thus, the edible straw 10 is not limited to simply being a straight tubular structure. In the first preferred embodiment, the second edible member 14 is concentrically located inside the first edible member 12. The first edible member 12 and the second edible member 14 are preferably directly coupled or laminated, forming the edible straw 10 as a single unit. In an alternative embodiment, the second edible member 14 can be concentrically located outside of the first edible member 12, or the first edible member 12 and second edible member 14 can be connected in an entirely different arrangement.

As shown in FIG. 2, in a first variation of the first preferred embodiment, the first edible member 12 encapsulates the second edible member 14. Encapsulation of the second edible member 14 permits the second edible member 14 to be composed of a less rigid material, such as a syrup or flavored liquid, that retains its tubular shape primarily by the presence of the first edible member 12.

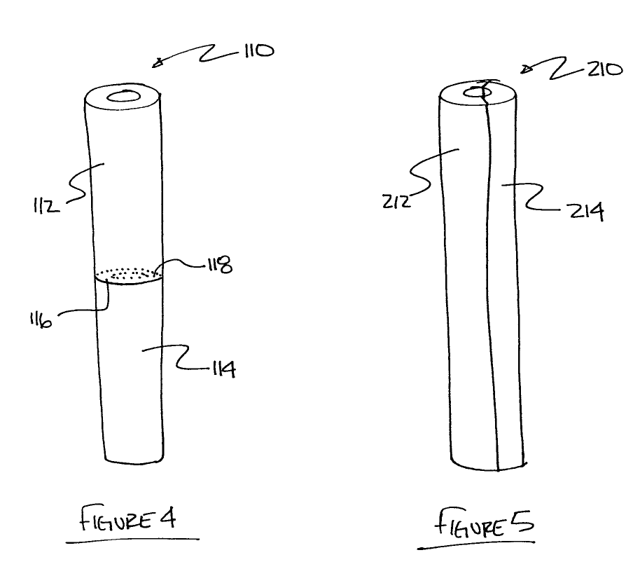

As shown in FIG. 3, in a second variation of the first preferred embodiment, a third edible member 20 is concentrically located inside the second edible member 14, which is concentrically located inside the first edible member 12. The third edible member 20 is formed in a tubular shape and is preferably composed of the same material as the first edible member 12. The tubular shape of the third edible member 20 permits liquid to move through the edible straw 10. In an alternative embodiment, the third edible member 20 can be connected to the first edible member 12 and the second edible member 14 such that the third edible member 20 is not concentrically located. In another alternative embodiment, the first edible member 12, the second edible member 14, and the third edible member 20 are concentrically located, but in a different radial order.

The composition of the first edible member 12 and the second edible member 14 is preferably different in one or more properties, such as flavor, texture, density, rigidity, or color. The combination of the first edible member 12 and the second edible member 14 provides desirable qualities, including unique flavors, appearance, and structure. Preferably, the first edible member 12 is hard candy and the second edible member 14 is soft candy. Hard candy has a relatively rigid structure, such as a JOLLY-RANCHER candy. Soft candy has a relatively non-rigid structure, such as bubble gum, taffy, and flavored syrup. Hard and soft candy compositions for the first edible member 12 and the second edible member 14 can be prepared pursuant to known procedures using ingredients known in the art of making hard and soft candy. Hard and soft candy preferably include a sweetener (such as sucrose, fructose, or corn syrup), a flavoring ingredient, and a coloring agent or dye. The composition of the hard and soft candy gives the candy a desired taste and distinct qualities that make it discernable from other hard and soft candy. Alternatively, the first edible member 12 and the second edible member 14 can be made from any suitable edible material and with any suitable method.

As shown in FIG. 4, in a second preferred embodiment, the edible straw 110 includes a first edible member 112 and a second edible member 114 that cooperatively form a rigid structure. Unless noted, the edible straw 110 of the second preferred embodiment is substantially similar to the edible straw 10 of the first preferred embodiment. The term rigid refers to relatively inflexible framework. The rigid structure, consequently, can permit the edible straw 110 to be used to puncture through the top of a perforated beverage lid. The rigid structure can improve the stability of the edible straw 110 and increase its ability to resist collapsing during use. The edible straw 110 may also include a third edible member, located concentrically or otherwise relative to the first edible member 112 and the second edible member 114.

In addition to being concentrically located, as described above, the first edible member 112 and the second edible member 114 may be connected to each other in different ways yet still cooperatively forming a rigid structure. As shown in FIG. 4, the second preferred embodiment includes one end 116 of the first edible member 112 connected to one end 118 of the second edible member 114, thus forming an elongated edible straw 110 with a rigid structure.

As shown in FIG. 5, in a third preferred embodiment, an edible straw 210 includes a first edible member 212 and a second edible member 214 that form complimentary sides of the edible straw 210. One of the first edible member 212 and the second edible member 214 has a C-shaped cross-section and the other of the first edible member 212 and the second edible member 214 has a complimentary-shaped cross-section. The term C-shaped is used to describe one half of the edible straw 210 that has been transversely bisected and observed from a cross-sectional view. The term complimentary-shaped refers to the other half of the bisected straw. As stated with previous preferred embodiments, the cylindrical shape described here does not preclude the edible straw 210 from having bends and edges. Aside from where noted, the edible straw 210 of the third preferred embodiment is substantially similar to the edible straw 110 of the second preferred embodiment.

In one method of using the edible straw 10, the user is preferably able to simultaneously enjoy and taste the flavors of the first edible member 12 and second edible member 14 and a liquid, such as soda pop. The edible straw 10 allows the sipping of liquid in a conventional way by placing the lower end of the straw in a liquid and the upper end in the user's mouth. If the user desires to consume only the edible straw 10 without sipping a liquid, then the lower end of the edible straw 10 may be held in the user's hand and used like a traditional sucker. As described for the first preferred embodiment, the first edible member 12 and the second edible member 14 serve as structural components of the edible straw 10 and permit liquid to flow from one end to the other end of the straw. The properties of the liquid that moves through the straw may be altered as the liquid or the user comes in contact with either one or both of the first edible member 12 and the second edible member 14. Properties of the liquid that are altered may include color and taste, and one example of the mechanism by which the alteration occurs is one or both of the first edible member 12 and second edible member 14 partially dissolving as the straw is being used.

In one method of manufacturing, composition of the first edible member 12 and the composition of the second edible member 14 are prepared separately and maintained in a non-rigid form. Using this method, the composition of the first edible member 12 and the composition of the second edible member 14 are fed into holding tanks, such as hoppers, capable of maintaining elevated temperatures and capable of depositing the composition of the first edible member 12 and the second edible member 14 sequentially over a tubular mold. The timed sequential deposition of the composition of the first edible member 12 and the composition of the second edible member 14 facilitates the formation of the edible straw 10 having two distinct layers. Alternatively, the second edible member 14 may be formed around a tubular mold and then the first edible member 12 may be deposited around the second edible member 14. Methods of manufacturing two-component hard candy are well known in the art and are described elsewhere, such as in U.S. Pat. No. 4,517,205, which is incorporated by reference. Of course, the edible straw 10 may be manufactured using any suitable method.

The foregoing discussion discloses and describes a preferred embodiment of the invention. One skilled in the art will readily recognize from such discussion, and from the accompanying drawings and claims, that changes and modifications can be made to the invention without departing from the true spirit and fair scope of the invention as defined in the following claims.

1. An edible straw, comprising: a first edible member; and a second edible member, wherein said first edible member is coupled to said second edible member.

2. The edible straw of claim 1, wherein said first edible member is formed in a tubular shape; and wherein said second edible member is formed in a tubular shape.

3. The edible straw of claim 2, wherein said first edible member is hard candy.

4. The edible straw of claim 3, wherein said second edible member is soft candy.

5. The edible straw of claim 2, wherein said first edible member and said second edible member are concentrically located.

6. The edible straw of claim 5, further comprising: a third edible member formed in a tubular shape and coupled to said first edible member and said second edible member.

7. The edible straw of claim 6, wherein said first edible member, said second edible member, and said third edible member are concentrically located.

8. The edible straw of claim 7, wherein said second edible member is located within said first edible member; and said third edible member is located within said second edible member.

9. The edible straw of claim 8, wherein said first edible member is hard candy.

10. The edible straw of claim 9, wherein said second edible member is soft candy.

11. The edible straw of claim 10, wherein said third edible member is hard candy.

12. The edible straw of claim 5, wherein said second edible member is encapsulated by said first edible member.

13. The edible straw of claim 12, wherein said first edible member is hard candy.

14. The edible straw of claim 13, wherein said second edible member is soft candy.

15. The edible straw of claim 1, wherein said first edible member and said second edible member cooperatively form a rigid structure.

16. The edible straw of claim 15, wherein said first edible member is hard candy.

17. The edible straw of claim 16, wherein said second edible member is soft candy.

18. The edible straw of claim 15, wherein said first edible member has an end, said second edible member has an end, and said first edible member and said second edible member are coupled to each other at these ends.

19. The edible straw of claim 15, wherein one of said first and second members has a C-shaped cross-section and the other of said first and second edible members has a complimentary-shaped cross-section.

20. The edible straw of claim 15, wherein said first edible member and said second edible member are concentrically located.

21. The edible straw of claim 20, further comprising: a third edible member coupled to said rigid structure.

22. The edible straw of claim 21, wherein said third edible member and said rigid structure are concentrically located.

23. The edible straw of claim 22, wherein said third edible member is concentrically located within said rigid structure.

24. The edible straw of claim 21, wherein said first edible member is hard candy.

25. The edible straw of claim 24, wherein said second edible member is soft candy.

26. The edible straw of claim 25, wherein said third edible member is hard candy.
